(19) United States
(12) Patent Application Publication
(10) Pub. No.: US 2007/0292794 A1
(43) Pub. Date: Dec. 20, 2007

(54) Imaging members and method for stabilizing a charge transport layer of an imaging member

(75) Inventors: Cindy C. Chen, Rochester, NY (US); Bryan Gar-Wah Ng, Toronto (CA); Lanhui Zhang, Webster, NY (US)

Correspondence Address: Marylou J. Lavoie, Esq. LLC, 1 Banks Road, Simsbury, CT, 06070, US

(73) Assignee: Xerox Corporation

(21) Appl. No.: 11/454,251

(22) Filed: Jun. 16, 2006

(51) Int. Cl. G03G 5/047

(52) U.S. Cl. 430/59.6; 430/133; 430/58.05; 399/159

(57) ABSTRACT

A method for stabilizing a single-layer charge transport layer or a two-layer charge transport layer including a first charge transport layer and a second pass charge transport layer of an imaging member, wherein the charge transport layer or layers comprises a charge transport material, includes a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing to form a polytetrafluoroethylene particle dispersion; c) carrying out a second mixing with a base charge transport layer or small molecule transport layer solution to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer.

### BACKGROUND

The present disclosure is generally related to imaging members, also referred to as photoreceptors, photosensitive members, and the like, and in embodiments to methods of treating the charge transport layer of electrophotographic imaging members. The imaging members may be used in copier, printer, fax machine, scanner, multifunction machines, and the like. In embodiments, the methods reduce scratching, abrasion, corrosion, fatigue, and cracking, and facilitate cleaning and durability of devices, for example active matrix imaging devices, such as active matrix belts.

In the art of electrophotography, a photoreceptor, imaging member, or the like, comprising a photoconductive insulating layer on a conductive layer is imaged by first uniformly electrostatically charging the surface of the photoconductive insulating layer. The photoreceptor is then exposed to a pattern of activating electromagnetic radiation such as light, which selectively dissipates the charge in the illuminated areas of the photoconductive insulating layer while leaving behind an electrostatic latent image in the non-illuminated areas. This electrostatic latent image may then be developed to form a visible image by depositing finely divided electroscopic toner particles on the surface of the photoconductive insulating layer. The resulting visible toner image can be transferred to a suitable receiving member such as paper. This imaging process may be repeated many times with reusable photoconductive insulating layers.

Electrophotographic imaging members or photoreceptors are usually multilayered photoreceptors that comprise a substrate support, an electrically conductive layer, an optional hole blocking layer, an optional adhesive layer, a charge generating layer, and a charge transport layer in either a flexible belt form or a rigid drum configuration. Multilayered flexible photoreceptor members may include an anti-curl layer on the backside of the substrate support, opposite to the side of the electrically active layers, to render the desired photoreceptor flatness.

The charge generating layer is capable of photogenerating hole/electron pairs and injecting the photogenerated holes into the charge transport layer in a negatively charged device.

Photoreceptors can also be single layer devices. For example, single layer organic photoreceptors typically comprise a photogenerating pigment, a thermoplastic binder, and hole and electron transport materials.

As more advanced, higher speed electrophotographic copiers, duplicators and printers were developed, the performance requirements for the xerographic components increased. Moreover, complex, highly sophisticated, duplicating and printing systems employing flexible photoreceptor belts, operating at very high speeds, have also placed stringent mechanical requirements and narrow operating limits as well on photoreceptors.

U.S. Pat. No. 4,263,990, which is hereby incorporated by reference herein in its entirety, discloses a layered photoreceptor having a separate charge generating (photogenerating) layer (CGL) and charge transport layer (CTL). The charge generating layer is capable of photogenerating hole/electron pairs and injecting the photogenerated holes into the charge transport layer in a negatively charged device. The photogenerating layer used in multilayered photoreceptors include, for example, inorganic photoconductive particles or organic photoconductive particles dispersed in a film forming polymeric binder. Inorganic or organic photoconductive materials may be formed as a continuous, homogeneous photogenerating layer.

Examples of photosensitive members having at least two electrically operative layers including a charge generating layer and diamine containing charge transport layer are disclosed in U.S. Pat. Nos. 4,265,990; 4,233,384; 4,306,008; 4,299,897; and 4,439,507, the disclosures of each of which are hereby incorporated by reference herein in their entireties.

Charge transport layers are known to be comprised of any of several different types of polymer binders that have a charge transport material dispersed therein. However, these conventional charge transport layers suffer from a fast, nearly catastrophic wear rate of 8 to 10 microns or more per 100 kilocycles when the photoreceptor is charged using an AC bias charging roll (BCR). The use of AC bias charging rolls to charge a photoreceptor surface is conventional in the art for forming images in low speed, for example up to about 40 ppm, imaging devices (e.g., copiers and printers). However, the corona generated from the AC current, applied to the BCR, decomposes on the top photoreceptor layer. The decomposed material can be easily removed by a cleaning blade. Such a repeated process during the printing cycle wears out the photoreceptor top layer very quickly.

Wear rate is a significant property in that it limits the life of the photoreceptor, and photoreceptor replacement in electrostatographic devices such as copiers and printers is very expensive. It is thus desirable to limit wear of the photoreceptor so as to achieve a long life photoreceptor.

For example, for small diameter organic photoreceptor drums typically used in low speed copiers and printers that are charged with an AC BCR, 100 kilocycles can translate into as few as 10,000 prints. CTL wear results in a considerable reduction in device sensitivity, which is a major problem in office copiers and printers that do not employ exposure control. In addition, the rapid wear of the top photoreceptor layer requires better cleaning of the debris from the photoreceptor surface in order to maintain good toner transfer and good copy quality.

U.S. Pat. No. 5,096,795, which is hereby incorporated by reference herein in its entirety, describes an electrophotographic imaging member comprising a charge transport layer comprised of a thermoplastic film forming binder, aromatic amine charge transport molecules and a homogeneous dispersion of at least one organic or inorganic particles having a particle diameter less than about 4.5 micrometers, the particles comprising a material selected from the group consisting of microcrystalline silica, ground glass, synthetic glass spheres, diamond, corundum, topaz, polytetrafluoroethylene, and waxy polyethylene, wherein said particles do not decrease the optical transmittancy or photoelectric functioning of the layer. The particles provide in various embodiments, coefficient of surface contact friction reduction, increased wear resistance, durability against tensile cracking, or improved adhesion of the layers without adversely affecting the optical and electrical properties of the imaging member.

U.S. Pat. No. 5,725,983, which is hereby incorporated by reference herein in its entirety, describes an electrophotographic imaging member including a supporting substrate having an electrically conductive layer, a hole blocking layer, an optional adhesive layer, a charge generating layer, a charge transport layer, an anticurl back coating, a ground strip layer and an optional overcoating layer, at least one of the charge transport layer, anticurl back coating, ground strip layer and the overcoating layer comprising a blend of inorganic and organic particles homogeneously distributed in a film forming matrix in a weight ratio of between about 3:7 and about 7:3, the inorganic particles and organic particles having a particle diameter less than about 4.5 micrometers. These electrophotographic imaging members may have a flexible belt form or rigid drum configuration.

It is known to incorporate small particles such as polytetrafluoroethylene (PTFE) in outer layers of a photoreceptor in an effort to facilitate cleaning and increase the hardness/durability of the outer photoreceptor layers. However, these particles have been difficult to disperse uniformly in the materials typically used for certain layers of the imaging member, particularly the charge transport layer. When a charge transport layer is formed from a dispersion in which such particles are poorly dispersed, the imaging member exhibits lesser electrical performance and poorer print quality. Poor dispersion causes high residual voltage (Vr) and Vr cycle-up, non-uniform coatings that contain large size particle aggregates, as well as non-uniform wear. The presence of large size aggregates lessens print quality as they cause white spots to occur in a solid image area. The large aggregates on the surface also cause difficulty in toner cleaning during the printing cycles. Poor cleaning can cause non-uniform density, such as streaks, to print-out. Poor cleaning also reduces toner transfer efficiency and increases toner waste.

Particles, such as polytetrafluoroethylene, in poor dispersion slowly settle over time in a CTL coating dispersion as a result of aggregation and the higher density of the PTFE than continuous media. Thus, it is necessary to stir or even vigorously agitate the dispersion in order to avoid settling of the PTFE particles. This is an impractical, expensive method for maintaining the uniformity of the dispersion over time, and renders storage and shipment of the dispersion difficult.

U.S. Pat. No. 6,326,111, which is hereby incorporated by reference herein in its entirety, describes a charge transport layer material for a photoreceptor including at least a polycarbonate polymer, at least one charge transport material, polytetrafluoroethylene particle aggregates having an average size of less than about 1.5 microns, hydrophobic silica, and a fluorine-containing polymeric surfactant dispersed in a solvent. The presence of the hydrophobic silica enables the dispersion to have superior stability by preventing settling of the PTFE particles. A resulting charge transport layer produced from the dispersion exhibits excellent wear resistance against contact with an AC bias charging roll, excellent electrical performance, and delivers superior print quality.

Active matrix (AMAT) photoreceptor devices, for example, AMAT belts, typically fail due to scratches, abrasions, cracking, and such. Overcoats have been sought to protect the inner layers. However, in certain applications improvement in electrical performance of these overcoats is desired. What is desired for a CTL is a method to increase the performance including the wear resistance for a charge transport layer of an imaging member and an imaging member prepared with an excellent, stable dispersion when particle additives, for example, polytetrafluorethylene particles, are included in the composition.

The appropriate components and process aspects of the each of the foregoing may be selected for the present disclosure in embodiments thereof.

### SUMMARY

Embodiments disclosed herein include a method for stabilizing a single-layer charge transport layer or a two-layer charge transport layer comprising a first charge transport layer and a second pass charge transport layer of an imaging member, wherein the charge transport layer or layers comprises a charge transport material, comprising a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing to form a polytetrafluoroethylene particle dispersion; c) carrying out a second mixing, in embodiments for example, with a base charge transport layer/small molecule transport layer (CTL/SMTL) solution, e.g., a solution of mTBD/Makrolon®/MeCl₂, to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer.

Embodiments disclosed herein further include an imaging member having an active matrix photoreceptor comprising an optional anti-curl layer; a substrate; an optional hole blocking layer; an optional adhesive layer; a charge generating layer; a single-layer charge transport layer or a two-layer charge transport layer comprising a first charge transport layer and a second pass charge transport layer, wherein the charge transport layer or layers comprises a charge transport material, the single-layer charge transport layer or second pass charge transport layer comprising a polytetrafluoroethylene particle dispersion-charge transport layer composition disposed as the single charge transport layer on a charge generation layer or as the second pass charge transport layer on a first charge transport layer; the polytetrafluoroethylene particle dispersion-charge transport layer composition being prepared by a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing to form a polytetrafluoroethylene particle dispersion; c) carrying out a second mixing, in embodiments, for example, with a base CTL/SMTL solution, e.g., a solution of mTBD/Makrolon®/MeCl₂, to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer; and an optional overcoat layer.

In addition, embodiments disclosed herein include an image forming apparatus for forming images on a recording medium comprising 1) a photoreceptor member having a charge retentive surface to receive an electrostatic latent image thereon, wherein said photoreceptor member comprises a metal or metallized substrate, a charge generating layer, and a single-layer charge transport layer or a two-layer charge transport layer comprising a first charge transport layer and a second pass charge transport layer, wherein the charge transport layer or layers comprises a charge transport material, the single-layer charge transport layer or second pass charge transport layer comprising a polytetrafluoroethylene particle dispersion-charge transport layer composition disposed as the single charge transport layer on the charge generation layer or as the second pass charge transport layer on the first charge transport layer; the polytetrafluoroethylene particle dispersion-charge transport layer composition being prepared by a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing to form a polytetrafluoroethylene particle dispersion; c) carrying out a second mixing, in embodiments, for example, with a base CTL/SMTL solution, e.g., a solution of mTBD/Makrolon/MeCl₂, to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer; 2) a development component to apply a developer material to said charge-retentive surface to develop said electrostatic latent image to form a developed image on said charge-retentive surface; 3) a transfer component for transferring said developed image from said charge-retentive surface to another member or a copy substrate; and 4) a fusing member to fuse said developed image to said copy substrate.

### BRIEF DESCRIPTION OF THE DRAWINGS

FIG. 1 is a graph showing viscosity versus shear rate for a Makrolon® solution with GF300 surfactant and for a Makrolon® solution without GF300 surfactant.

FIG. 2 is a series of transmission light micrographs providing a flow visualization for polytetrafluoroethylene (PTFE) doped Makrolon® dispersions having GF300 surfactant loadings of 5%, 13.6%, 30.8%, and 48% versus total weight of PTFE.

FIG. 3 provides a series of light microscopy images of cross-sections of coated films and flow visualizations of PTFE-particle dispersion-charge transport layer compositions with various ratios of GF300:MP1100.

FIG. 4 provides a series of flow visualizations of coating compositions comparing Daikin L-2 PTFE and DuPont MP1100 PTFE at various GF300:PTFE ratios.

FIG. 5 is a normalized PIDC graph showing potential (y-axis) versus exposure (x-axis) of devices having 0, 2.0%, and 3.0% GF300 loading versus total weight of PTFE.

FIG. 6 is an enlarged insert of the high exposure region of FIG. 5.

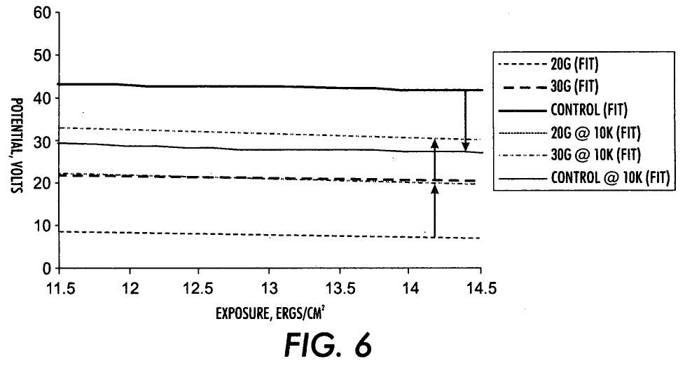

### DETAILED DESCRIPTION

A method for preparing an imaging member having a stabilized particulate single-layer charge transport layer or a two-layer charge transport layer of an imaging member and in embodiments of an imaging member an active matrix (AMAT) photoreceptor is described. In embodiments, polytetrafluoroethylene (PTFE) particles are incorporated into a top layer of a charge transport layer to facilitate cleaning, enhance durability, and increase the lifetime of the photoreceptor member. In embodiments, the present method for preparing a stabilized single-layer PTFE particle dispersion-charge transport composition or a second pass layer comprising a PTFE-particle dispersion-charge transport composition for a two-layer charge transport layer of an imaging member having, for example, in embodiments, an active matrix photoreceptor, includes or is prepared by a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing, for example, but not limited to, milling, to form a polytetrafluoroethylene particle dispersion; c) carrying out a second mixing with a base CTL/SMTL solution, e.g., a solution of mTBD/Makrolon/MeCl₂, to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer.

To increase the wear resistance of the charge transport layer, polytetrafluoroethylene (PTFE) particles are included in the charge transport layer material. Any commercially available PTFE particle may be employed, including, for example, MP1100 and MP1500 from Dupont Chemical and L2 and L4, Luboron from Daikin Industries Ltd., Japan. It is desired to maintain PTFE at a size close to the primary particle size.

The particle size of the PTFE particles are selected as desired. In embodiments, the polytetrafluoroethylene particles are selected at a primary particle size of from about 0.05 micrometers to about 2 micrometers or at from about 0.2 micrometer to about 0.4 micrometer.

In embodiments, the surface of the PTFE particles are relatively smooth to prevent air bubble generation during the dispersion preparation process. Air bubbles in the dispersion can cause coating defects on the surface, which initiate toner cleaning failure.

PTFE particles are selected, in embodiments, in an amount of from about 0.1 to about 30 percent by weight, or from about 2 to about 20 percent by weight, of the charge transport layer material.

In embodiments, the polytetrafluoroethylene particle dispersion contains from about 5 to about 45 percent by weight of the polytetrafluoroethylene particles versus the weight of total dispersion and from about 0.5 to about 10 percent by weight of the surfactant versus weight of PTFE.

Previously, it has been difficult to maintain the stability of a charge transport layer material dispersion upon the incorporation of PTFE or other similar particles therein. As discussed above, the PTFE tends to settle over time in the dispersion due to its aggregation and higher density than continuous media. It has been found that if PTFE particles are incorporated into the dispersion along with an adequate surfactant or stabilizer, after proper processing the PTFE particles will be uniformly dispersed in dispersion and maintain particle size and uniformity.

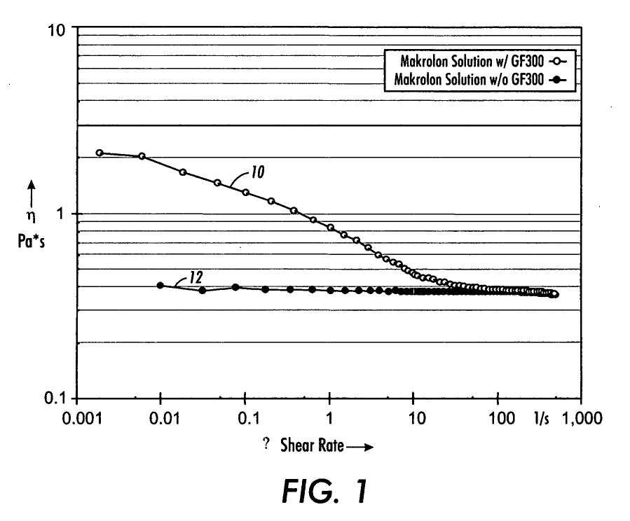

Typical stabilizers for PTFE particles include fluorine-containing polymeric surfactants such as materials with fluorinated polymethacrylate chains. These types of fluorine-containing polymeric surfactants are described in U.S. Pat. No. 5,637,142, which is hereby incorporated by reference herein in its entirety. For example, GF300, commercially available from Daikin Industries, has been used as a surfactant and stabilizer for PTFE particles and has been incorporated into organic photoreceptor charge transport layers containing PTFE. GF300 type surfactant is believed to behave differently in AMAT systems as compared to organic photoreceptor systems. This is believed to be due to interactions between GF300 surfactant and the small molecule transport layer (SMTL) binder, for example Makrolon® polycarbonate available from Bayer Material Science, in the corresponding solvent systems. In rheological studies, it is observed that there is a significantly higher viscosity of Makrolon® solution without PTFE in the presence of GF300 at low shear rates, suggesting Makrolon® and GF300 interactions. Refer, for example, to FIG. 1, illustrating viscosity as a function of shear rate for Makrolon® solutions including GF300, line 10, and Makrolon® solutions without GF300, line 12.

In embodiments, the surfactant selected comprises a fluorine-containing graft copolymer based on methylmethacrylate. For example, in embodiments, the surfactant is selected from the group consisting of GF300, Novec™ fluorosurfactant FC-4430, Novec™ fluorosurfactant FC-4432, and the like, available from Minnesota Mining and Manufacturing, Zonyl® flouroadditives, such as but not limited to Zonyl® FS-300, available from DuPont, and mixtures and combinations thereof.

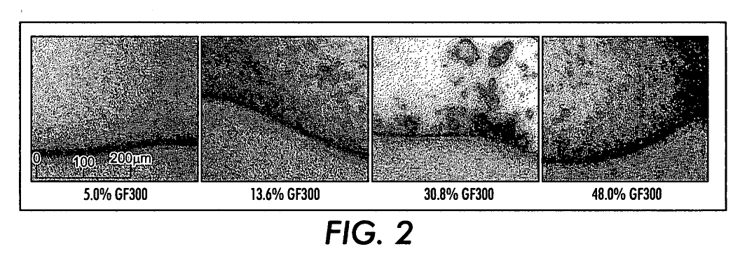

Without wishing to be bound by theory, it is believed that when PTFE particles are introduced into the system, Makrolon® competes with PTFE for stabilizer such as GF300, creating a tendency to destabilize PTFE/surfactant/MeCl₂ dispersions. This interaction is illustrated by PTFE/Makrolon®/MeCl₂ dispersions having high GF300 surfactant doping levels, that is, the small molecule transport layer dispersion without electron transport materials. FIG. 2 illustrates flow visualization results, where excess GF300 doping results in severe aggregation of PTFE particles. Flow visualization is illustrated for PTFE-doped Makrolon®/MeCl₂ dispersions having GF300 loading of 5.0%, 13.6%, 30.8%, and 48.0% GF300 (versus weight of PTFE).

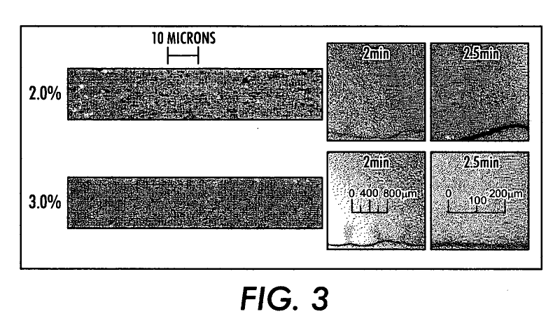

FIG. 3 illustrates light microscopy cross sections and flow visualization results for PTFE-doped SMTL, each having a PTFE content of 7.4%, wherein % is by weight based upon the total weight of solid, and having a GF300 loading of 2.0% or 3.0 weight % based upon the weight of PTFE.

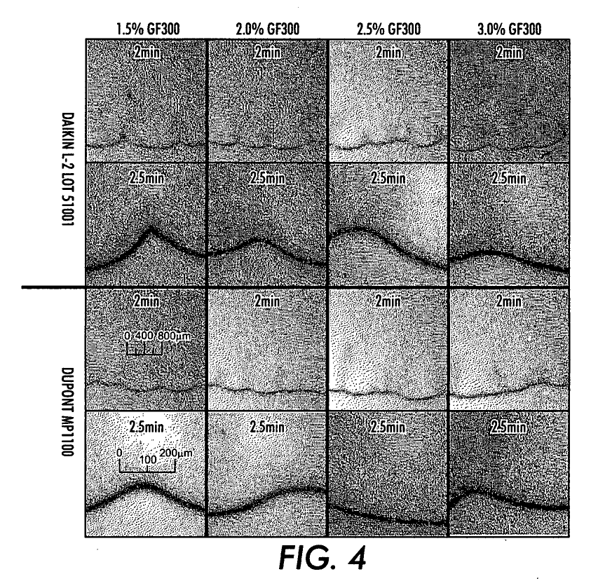

FIG. 4 illustrates flow visualizations for SMTL compositions including Daikin L-2, upper set, and Dupont MP1100, lower set, having 7.4 weight % of PTFE based upon the total weight of PTFE-doped SMTL solid and having GF300 loadings of 1.5%, 2.0%, 2.5%, and 3.0% by weight based upon the weight of the PTFE.

The GF300 or other surfactant/stabilizer is selected in embodiments at a level to maintain the required dispersion quality and good electrical properties of the photoreceptor. Too little GF300 may cause large aggregates of the PTFE particles due to starvation of surfactant/stabilizer. Too much GF300 may result in high residual voltage and possibly the aggregation of PTFE particles. The selected amount of GF300 in the dispersion depends on the amount of PTFE. As the quantity of PTFE is increased, the amount of GF300 is in embodiments increased so as to maintain the PTFE dispersion quality. For example, in embodiments, the surfactant (GF300) to PTFE weight ratio is selected at from about 1 to about 4% or from about 1.5 to about 3%.

To break up PTFE particles into a desired particle size and keep them dispersed, milling and stabilization are desired. In embodiments of the present method, PTFE is wetted with surfactant (e.g., GF300) solution, prior to milling. A slurry comprising solvent, PTFE, and surfactant/stabilizer are mixed, for example overnight, to form an unprocessed dispersion. The unprocessed dispersion of polytetrafluoroethylene particle is added and mixed to a composition comprising at least one polymer binder and at least one second solvent which is the same or different from the first solvent. After mixing, a processing step comprising, for example but not limited to processing and/or milling, is conducted to form a polytetrafluoroethylene particle dispersion. Any suitable device can be employed including mixing with a mixing stirrer, Cavipro® device, a ball mill, a homogenizer or a micro-fluidizer, or milling with an attritor or a dynomill with grinding media, such as glass beads or zirconium oxide beads. For AMAT applications, milling is desirably performed with an attritor. The slurry is transferred for example to the attritor, and the PTFE is milled without SMTL binder (e.g., without Makrolon®). Makrolon® is not added in the milling step in order to avoid any competition for GF300. A PTFE lined cup with glass beads is selected in embodiments to minimize any potential electrical impact.

The processed dispersion is then added to the base SMTL composition comprising binder, charge transport material, and solvent, for example a Makrolon®/mTBD/MeCl₂ solution, and mixed to prepare a final dispersion for coating. Advantageously, in embodiments, dispersion quality remains high overtime without any aging effects up to one month. Settling tests illustrate that standing stability is high in dispersions prepared in accordance with the present method.

In embodiments, low shear blending is selected to prevent the dispersion from settling, such as for long term storage applications. For example, low shear stress of from about 10⁻³ Pa to about 5 Pa, or about 0.05 Pa to about 1 Pa are selected. Vigorous, high shear mixing is avoided, in embodiments, because there is a tendency for GF300 to detach from the surface of the PTFE particle, thus allowing the GF300 to be consumed by binder (e.g., Makrolon®) resulting in deterioration of the PTFE-doped SMTL dispersion.

The polymer binders for the SMTL layer and top layer can comprise any suitable material as is known. For example, in embodiments, the at least one polymer binder can be selected from the group consisting of polyester, polystyrene, polycarbonate, and mixtures and combinations thereof. In embodiments, the polymer binder is Makrolon®.

The charge-transport component transports charge from the charge-generating layer to the surface of the photoreceptor. Often, the charge-transport component is made up of several materials, including electrically active organic-resin materials such as polymeric arylamine compounds, polysilylenes (such as poly(methylphenyl silylene), poly(methylphenyl silylene-co-dimethyl silylene), poly(cyclohexylmethyl silylene), and poly(cyanoethylmethyl silylene)), and polyvinyl pyrenes. The charge-transport component typically contains at least one compound having an arylamine, enamine, or hydrazone group. The compound containing the arylamine may be dispersed in a resinous binder, such as a polycarbonate or a polystyrene. In various exemplary embodiments, a charge transport layer can include aryl amine molecules. In various exemplary embodiments, a charge transport layer can include aryl amines of the following formula:

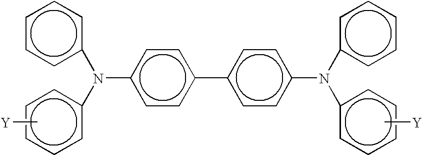

wherein Y is selected from the group consisting of alkyl having from about 1 to about 20 carbons, or from about 2 to about 20 carbons, and halogen, such as fluorine, chlorine, bromine, and iodine, and wherein the aryl amine of the above formula is dispersed in a highly insulating and transparent resinous binder. In various exemplary embodiments, the arylamine alkyl is methyl, the halogen is chlorine, and the resinous binder is selected from the group consisting of polycarbonates and polystyrenes. A selected compound having an arylamine group is N,N′-diphenyl-N,N-bis(3-methyl phenyl)-1,1′-biphenyl-4,4′-diamine.

Any suitable solvent or solvent system can be selected for embodiments herein in forming the dispersion. For example, the solvent system is selected in embodiments to assist in obtaining a stable dispersion of the foregoing components. Examples of suitable solvents include, but are not limited to, solvents selected from the group consisting of tetrahydrofuran, toluene, hexane, cyclohexane, cyclohexanone, methylene chloride, 1,1,2-trichloroethane, monochlorobenzene, and the like, and mixtures and combinations thereof. The total solid to total solvent can be selected in embodiments at an amount of from about 10:90 weight % to about 35:65 weight %, or from about 15:85 weight % to about 30:70 weight %. In embodiments, the at least one first solvent and the at least one second solvent are independently selected from the group consisting of methylene chloride, tetrahydrofuran, monochlorobenzene, toluene, hexane, cyclohexane, cyclohexanone, 1,1,2-trichloroethane, monochlorobenzene and mixtures and combinations thereof.

Additional additives can be added as desired. For example, antioxidants or leveling agents can be included in the charge transport layer material as needed or desired.

In preparing a photoreceptor, a single-layer charge transport layer or a multiple layer charge transport layer can be applied to a photoreceptor. More in particular, a single charge transport layer or multiple pass charge transport layers can be formed upon a previously formed charge generating layer. As described herein, a second pass charge transport layer is prepared by contacting surfactant, PTFE particles, and at least one first solvent in the absence of binder to form an unprocessed PTFE particle dispersion. The unprocessed PTFE particle dispersion is added to a composition comprising at least one binder and at least one second solvent which is the same or different from the first solvent with mixing to form an unprocessed PTFE particle dispersion with moderate viscosity. After carrying out processing, for example milling, to form a polytetrafluoroethylene particle dispersion, a second mixing with base SMTL solution is conducted to form a final polytetrafluoroethylene-particle dispersion-charge transport layer composition. The PTFE particle dispersion-charge transport layer composition is disposed on the charge generation layer or as a second pass upon a first charge transport layer comprising at least one charge transport material. Any suitable technique may be employed to mix and thereafter apply the single charge transport layer to the charge generating layer or the second pass charge transport layer comprising PTFE particle dispersion-charge transport layer composition to the first charge transport layer. Selected application techniques include, but are not limited to, spraying, dip coating, slot coating, slide coating, die coating, roll coating, wire wound rod coating, draw bar coating, and the like.

The dried charge transport layer has a thickness, in embodiments, of from about 10 to about 50 or from about 15 to about 35 micrometers. If used as a second pass charge transport layer, the dried thickness of the second pass PTFE particle dispersion-charge transport layer has a thickness, in embodiments, of from about 5 to about 30 or from about 8 to about 20 micrometers.

Embodiments disclosed herein further include an imaging member having an active matrix photoreceptor comprising an optional anti-curl layer; a substrate; an optional hole blocking layer; an optional adhesive layer; a charge generating layer; a charge transport layer; polytetrafluoroethylene particle dispersion-charge transport layer composition disposed on the charge transport layer; the polytetrfluoroethylene particle dispersion-charge transport layer composition being prepared by contacting surfactant, polytetrafluoroethylene particles and at least one first solvent in the absence of polymer binder to form an unprocessed polytetrafluoroethylene particle dispersion; adding the unprocessed polytetrafluoroethylene particle dispersion to a composition comprising at least one polymer binder and at least one second solvent which is the same or different from the first solvent; and mixing to form an unprocessed polytetrafluoroethylene particle dispersion with moderate viscosity; processing, for example milling, to form a polytetrafluoroethylene particle dispersion. A second mixing with base SMTL solution is conducted to form a final polytetrafluoroethylene particle dispersion-charge transport layer composition; and an optional overcoat layer. As described, the charge transport layer can comprise in embodiments a single charge transport layer disposed upon a charger generation layer or a two-layer charge transport configuration comprising a first charge transport layer disposed on a charge generation layer and a second pass charge transport layer disposed upon the first charge transport layer.

Any suitable multilayer photoreceptor may be employed in present imaging member. The various layers may be applied in any suitable order to produce either positive or negative charging photoreceptors. For example, the charge generating layer may be applied prior to the charge transport layer, as illustrated in U.S. Pat. No. 4,265,990, which is hereby incorporated by reference herein in its entirety, or the charge transport layer may be applied prior to the charge generating layer, as illustrated in U.S. Pat. No. 4,346,158, which is hereby incorporated by reference herein in its entirety. In selected embodiments, the charge transport layer is formed upon a charge generating layer and the second pass charge transport layer is formed upon the charge transport layer.

The supporting substrate can be selected to include a conductive metal substrate or a metallized substrate. While a metal substrate is substantially or completely metal, the substrate of a metallized substrate is made of a different material that has at least one layer of metal applied to at least one surface of the substrate. The material of the substrate of the metallized substrate can be any material for which a metal layer is capable of being applied. For instance, the substrate can be a synthetic material, such as a polymer. In various exemplary embodiments, a conductive substrate is, for example, at least one member selected from the group consisting of aluminum, aluminized or titanized polyethylene terephthalate belt (Mylar®).

Any metal or metal alloy can be selected for the metal or metallized substrate. Typical metals employed for this purpose include aluminum, zirconium, niobium, tantalum, vanadium, hafnium, titanium, nickel, stainless steel, chromium, tungsten, molybdenum, mixtures and combinations thereof, and the like. Useful metal alloys may contain two or more metals such as zirconium, niobium, tantalum, vanadium, hafnium, titanium, nickel, stainless steel, chromium, tungsten, molybdenum, mixtures and combinations thereof, and the like. Aluminum, such as mirror-finish aluminum, is selected in embodiments for both the metal substrate and the metal in the metallized substrate. All types of substrates may be used, including honed substrates, anodized substrates, bohmite-coated substrates and mirror substrates.

A metal substrate or metallized substrate can be selected. Examples of substrate layers selected for the present imaging members include opaque or substantially transparent materials, and may comprise any suitable material having the requisite mechanical properties. Thus, for example, the substrate can comprise a layer of insulating material including inorganic or organic polymeric materials, such as Mylar®, a commercially available polymer, Mylar® containing titanium, a layer of an organic or inorganic material having a semiconductive surface layer, such as indium tin oxide or aluminum arrange thereon, or a conductive material such as aluminum, chromium, nickel, brass or the like. The substrate may be flexible, seamless, or rigid, and may have a number of different configurations. For example, the substrate may comprise a plate, a cylindrical drum, a scroll, and endless flexible belt, or other configuration. In some situations, it may be desirable to provide an anticurl layer to the back of the substrate, such as when the substrate is a flexible organic polymeric material, such as for example polycarbonate materials, for example Makrolon® a commercially available material.

Optionally, a hole blocking layer is applied, in embodiments, to the substrate. Generally, electron blocking layers for positively charged photoreceptors allow the photogenerated holes in the charge generating layer at the top of the photoreceptor to migrate toward the charge (hole) transport layer below and reach the bottom conductive layer during the electrophotographic imaging process. Thus, an electron blocking layer is normally not expected to block holes in positively charged photoreceptors such as photoreceptors coated with a charge generating layer over a charge (hole) transport layer. For negatively charged photoreceptors, any suitable hole blocking layer capable of forming an electronic barrier to holes between the adjacent photoconductive layer and the underlying substrate layer may be utilized. A hole blocking layer may comprise any suitable material. Typical hole blocking layers utilized for the negatively charged photoreceptors may include, for example, polyamides such as Luckamide® (a nylon-6 type material derived from methoxymethyl-substituted polyamide), hydroxyl alkyl methacrylates, nylons, gelatin, hydroxyl alkyl cellulose, organopolyphosphazenes, organosilanes, organotitanates, organozirconates, silicon oxides, zirconium oxides, zinc oxides, titanium oxides, and the like. In embodiments, the hole blocking layer comprises nitrogen containing siloxanes.

The blocking layer, as with all layers herein, may be applied by any suitable technique such as, but not limited to, spraying dip coating, draw bar coating, gravure coating, silk screening, air knife coating, reverse roll coating, vacuum deposition, chemical treatment, and the like.

An adhesive layer may optionally be applied such as to the hole blocking layer. The adhesive layer may comprise any suitable material, for example, any suitable film forming polymer. Typical adhesive layer materials include, but are not limited to, for example, copolyester resins, polyarylates, polyurethanes, blends of resins, and the like. Any suitable solvent may be selected in embodiments to form an adhesive layer coating solution. Typical solvents include, but are not limited to, for example, tetrahydrofuran, toluene, hexane, cyclohexane, cyclohexanone, methylene chloride, 1,1,2-trichloroethane, monochlorobenzene, and mixtures thereof, and the like.

The charge-generating component converts light input into electron-hole pairs. Examples of compounds suitable for use as the charge-generating component include vanadyl phthalocyanine, metal phthalocyanines (such as titanyl phthalocyanine, chlorogallium phthalocyanine, hydroxygallium phthalocyanine, and alkoxygallium phthalocyanine), metal-free phthalocyanines, benzimidazole perylene, amorphous selenium, trigonal selenium, selenium alloys (such as selenium-tellurium, selenium-tellurium arsenic, selenium arsenide), chlorogallium phthalocyanin, and mixtures and combinations thereof. In various exemplary embodiments, a photogenerating layer includes metal phthalocyanines and/or metal free phthalocyanines. In various exemplary embodiments, a photogenerating layer includes at least one phthalocyanine selected from the group consisting of titanyl phthalocyanines or hydroxygallium phthalocyanines. In various exemplary embodiments, a photogenerating layer includes hydroxygallium phthalocyanine.

The charge generating layer may comprise in embodiments single or multiple layers comprising inorganic or organic compositions and the like. Suitable polymeric film-forming binder materials for the charge generating layer and/or charge generating pigment include, but are not limited to, thermoplastic and thermosetting resins, such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, amino resins, phenylene oxide resins, terephthalic acid resins, phenoxy resins, epoxy resins, phenolic resins, polystyrene and acrylonitrile copolymers, polyvinyl chloride, vinylchloride and vinyl acetate copolymers, acrylate copolymers, alkyd resins, cellulosic film formers, poly(amideimide), styrene-butadiene copolymers, vinylidinechloride-vinylchloride copolymers, vinylacetate-vinylidenechloride copolymers, carboxyl-modified vinyl acetate-vinylchloride copolymers, styrene-alkyd resins, polyvinylcarbazole, and mixtures thereof.

The charge-generating component may also contain a photogenerating composition or pigment. The photogenerating composition or pigment may be present in the resinous binder composition in various amounts, ranging from about 5% by volume to about 90% by volume versus the volume of total solids; or from about 20% by volume to about 75% by volume versus the volume of total solids. When the photogenerating component contains photoconductive compositions and/or pigments in the resinous binder material, the thickness of the layer typically ranges from about 0.1 μm to about 5.0 μm, or from about 0.2 μm to about 3 μm. The photogenerating layer thickness is often related to binder content, for example, higher binder content compositions typically require thicker layers for photogeneration. Thicknesses outside these ranges may also be selected.

The thickness of the imaging device typically ranges from about 2 μm to about 100 μm; from about 5 μm to about 50 μm, or from about 10 μm to about 30 μm. The thickness of each layer will depend on how many components are contained in that layer, how much of each component is desired in the layer, and other factors familiar to those in the art.

As with the various other layers described herein, the photogenerating layer can be applied to underlying layers by any desired or suitable method. Any suitable technique may be employed to mix and thereafter apply the photogenerating layer coating mixture with typical application techniques including, but not being limited to, spraying, dip coating, roll coating, wire wound rod coating, die coating, slot coating, slide-coating, and the like. Drying, as with the other layers herein, can be effected by any suitable technique, such as, but not limited to, oven drying, infrared radiation drying, air drying, and the like.

Optionally, an overcoat layer can be employed to improve resistance of the photoreceptor to abrasion. An optional anticurl back coating may further be applied to the surface of the substrate opposite to that bearing the photoconductive layer to provide flatness and/or abrasion resistance where a web configuration photoreceptor is desired. These overcoating and anticurl back coating layers are well known in the art, and can comprise for example thermoplastic organic polymers or inorganic polymers that are electrically insulating or slightly semiconductive. In embodiments, overcoatings are continuous and have a thickness of less than about 10 microns, although the thickness can be outside this range. The thickness of anticurl backing layers is selected in embodiments sufficient to balance substantially the total forces of the layer or layers on the opposite side of the substrate layer.

Various exemplary embodiments encompassed herein include a method of imaging which includes generating an electrostatic latent image on an imaging member, developing a latent image, and transferring the developed electrostatic image to a suitable substrate.

Further embodiments encompassed within the present disclosure include methods of imaging and printing with the photoresponsive devices illustrated herein. Various exemplary embodiments include methods including forming an electrostatic latent image on an imaging member; developing the image with a toner composition including, for example, at least one thermoplastic resin, at least one colorant, such as pigment, at least one charge additive, and at least one surface additive; transferring the image to a necessary member, such as, for example any suitable substrate, such as, for example, paper; and permanently affixing the image thereto. In various exemplary embodiments in which the embodiment is used in a printing mode, various exemplary imaging methods include forming an electrostatic latent image on an imaging member by use of a laser device or image bar; developing the image with a toner composition including, for example, at least one thermoplastic resin, at least one colorant, such as pigment, at least one charge additive, and at least one surface additive; transferring the image to a necessary member, such as, for example any suitable substrate, such as, for example, paper; and permanently affixing the image thereto.

In a selected embodiment, an image forming apparatus for forming images on a recording medium comprises a) a photoreceptor member having a charge retentive surface to receive an electrostatic latent image thereon, wherein said photoreceptor member comprises a metal or metallized substrate, a charge generating layer, and a charge transport layer comprising charge transport materials dispersed therein; a polytetrafluoroethylene particle dispersion-charge transport layer composition disposed on the charge transport layer; the polytetrafluoroethylene particle dispersion-charge transport layer composition being prepared by contacting surfactant, polytetrafluoroethylene particles and at least one first solvent in the absence of polymer binder to form an unprocessed polytetrafluoroethylene particle dispersion; adding the unprocessed polytetrafluoroethylene particle dispersion to a composition comprising at least one polymer binder and at least one second solvent which is the same or different from the first solvent; and mixing to form an unprocessed polytetrafluoroethylene particle dispersion with moderate viscosity. After carrying out processing and/or milling to form a polytetrafluoroethylene particle dispersion, a second mixing with base SMTL solution is conducted to form the final polytetrafluoroethylene particle dispersion-charge transport layer composition; b) a development component to apply a developer material to said charge-retentive surface to develop said electrostatic latent image to form a developed image on said charge-retentive surface; c) a transfer component for transferring said developed image from said charge-retentive surface to another member or a copy substrate; and d) a fusing member to fuse said developed image to said copy substrate. As described, the charge transport layer can comprise in embodiments a single charge transport layer disposed upon a charger generation layer or a two-layer charge transport configuration comprising a first charge transport layer disposed on a charge generation layer and a second pass charge transport layer disposed upon the first charge transport layer.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

Examples 1 (control, no PTFE) through 9 were prepared as follows. For each example, 5.28 grams of PE2200, 6.98 grams of PTFE and 66 grams of MeCl₂ were rolled in a 60 milliliter bottle. GF300 surfactant was added to this preslurry and rolled overnight, with the GF300 being added to Examples 1-9 in an amount, respectively, of 0 (control), 1.5, 2.0, 2.5 and 3% GF300 versus PTFE weight. Examples 2-5 were prepared with Daikin L-2. Examples 6-9 were prepared with Dupont MP1100. The slurry was then put into a PTFE lined 01S attritor with 50 grams of 1 millimeter pitch glass beads. The attritor was run at its maximum power. The solution was milled for 35 minutes, with MeCl₂ added at 10 minute intervals to maintain a constant liquid level. The processed slurry was filtered through a 400 micrometer strainer. The slurry was measured for solid content (%) and rolled overnight. The slurry was then added to a base composition comprising mTBD/Makrolon® (50/50, wt/wt) in MeCl₂ to achieve a 7.4% PTFE loading versus solid weight for each solution. The dispersion was rolled for at least one day before dispersion testing.

Samples 1-5 were prepared from the above examples by hand coating each of Examples 1-5 using a 2 mil bar onto a first pass small molecule transport layer comprising mTBD/Makrolon® (50/50, wt/wt). After coating, the sample devices were allowed to ambient dry for 5 minutes, then placed into an oven for 1 minute at 120° C. Electrical, crack, and scratch tests were conducted. The tests are briefly described as follows.

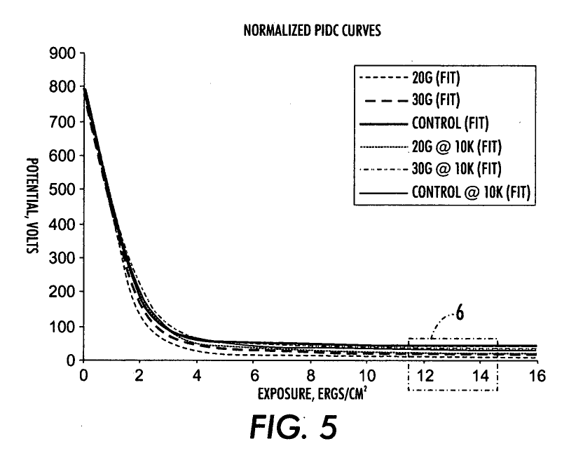

FIG. 5 illustrates electrical testing results for Examples 1, 3 and 5.

Table 1 provides crack resistance and scratch resistance test results, wherein the devices of Examples 1-9 are rated on a scale from 1 to 5, wherein 1 is the worst and 5 is the best.

Scratch Resistance Test: Samples were cut into strips of 1 inch in width by 12 inches in length and were flexed in a tri-roller flexing system. Each belt was under a 1.1 lb/inch tension and each roller was ⅛ inches in diameter. A polyurethane “spots blade” was placed in contact with each belt at an angle between about 5 and about 15 degrees. Carrier beads of about 100 micrometers in size were attached to the spots blade by the aid of double tape. Belts were flexed for 200 cycles. Rq, the root mean square roughness of flexed surface, was chosen to be the standard metric for scratch resistance assessment. A rating of 1 being the worst, is for Rq greater than 0.3 microns, 2 for Rq between 0.2 and 0.3 micron, 3 for Rq between 0.15 and 0.2, 4 for Rq between 0.1 and 0.15 and 5 being the best scratch resistance is for Rq less than 0.1 micron.

Crack Resistance Test: Samples were cut into strips of 1 inch in width by 12 inches in length and were tested for mechanical crack resistance, by being flexed on a tri-roller fixture with ¼ inch diameter rolls for 5,000 cycles. Cracks could be formed on the surface but not deep enough to be printable. The flexed areas were then exposed to corona effluent for 20 minutes to increase the size of the cracks, if any, into the top charge transport layer. The flexed and exposed areas were then printed for crack assessment. Cracks, if any, appeared as black spots. A rating was assigned to each assessment as follows: 1 being the worst with 70% to 100% of the flexed and exposed areas covered by the black spots, 2 being 40% to 70% covered by the black spots, 3 being 20% to 40%, 4 being 10% to 20% and 5 being less than 10% of the areas covered by the black spots.

TABLE 1

| | | | Crack | Scratch |
|---|---|---|---|---|
| Example # | GF300 % | PTFE | Resistance | Resistance |
| 1 | 0 | N/A | 4 | 2 |
| (Control) | | | | |
| 2 | 1.5 | Daikin L-2 | 4 | 2 |
| 3 | 2.0 | Daikin L-2 | 4 | 2 |
| 4 | 2.5 | Daikin L-2 | 3 | 2 |
| 5 | 3.0 | Daikin L-2 | 3 | 2 |
| 6 | 1.5 | DuPont | 4 | 3 |
| | | MP1100 | | |
| 7 | 2.0 | DuPont | 4 | 4 |
| | | MP1100 | | |
| 8 | 2.5 | DuPont | 4 | 4 |
| | | MP1100 | | |
| 9 | 3.0 | DuPont | 4 | 4 |
| | | MP1100 | | |

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A method for stabilizing a single-layer charge transport layer or a two-layer charge transport layer comprising a first charge transport layer and a second pass charge transport layer of an imaging member, wherein the charge transport layer or layers comprises a charge transport material, comprising:
a) contacting surfactant, polytetrafluoroethylene particles and at least one first solvent in the absence of polymer binder to form a polytetrafluoroethylene particle slurry;
b) adding and mixing the polytetrafluoroethylene particle slurry of a) to a composition comprising at least one polymer binder and at least one second solvent which is the same or different from the first solvent and processing to form a polytetrafluoroethylene particle dispersion;
c) carrying out a second mixing with a base charge transport layer or small molecule transport layer solution to form a polytetrafluoroethylene particle dispersion-charge transport layer composition; and
d) disposing the polytetrafluoroethylene particle dispersion-charge transport layer composition formed in c) as a single-layer charge transport layer onto a charge generation layer or as a second pass charge transport layer onto a first charge transport layer.

2. The method of claim 1, wherein the polytetrafluoroethylene particle dispersion contains from about 5 to about 45 percent by weight of the polytetrafluoroethylene particles versus the weight of total dispersion and from about 0.5 to about 10 percent by weight of the surfactant versus weight of PTFE.

3. The method of claim 1, wherein the surfactant is a fluorine-containing graft copolymer based on methylmethacrylate.

4. The method of claim 1, wherein the surfactant is selected from the group consisting of GF300, Novec™ fluorosurfactant FC-4430, Novec™ fluorosurfactant FC-4432, Zonyl® FS-300, and mixtures and combinations thereof.

5. The method of claim 1, wherein the at least one first solvent and the at least one second solvent are independently selected from the group consisting of methylene chloride, tetrahydrofuran, monochlorobenzene, toluene, hexane, cyclohexane, cyclohexanone, 1,1,2-trichloroethane, monochlorobenzene and mixtures and combinations thereof.

6. The method of claim 1, wherein the polytetrafluoroethylene particles have a primary particle size of from about 0.05 micrometers to about 2 micrometers.

7. The method of claim 1, wherein the polytetrafluoroethylene particles have a primary particle size of from about 0.2 micrometer to about 0.4 micrometer.

8. The method of claim 1, wherein the at least one polymer binder is a polycarbonate binder.

9. The method of claim 1, wherein the at least one polymer binder is selected from the group consisting of polyester, polystyrene, polycarbonate, and mixtures and combinations thereof.

10. The method of claim 1, wherein the at least one polymer binder is Makrolon®.

11. The method of claim 1, wherein the second mixing comprises stirring the material at a shear of about 10⁻³ Pa to about 5 Pa.

12. An imaging member having an active matrix photoreceptor comprising:
an optional anti-curl layer;
a substrate;
an optional hole blocking layer;
an optional adhesive layer;
a charge generating layer;
a single-layer charge transport layer or a two-layer charge transport layer comprising a first charge transport layer and a second pass charge transport layer, wherein the charge transport layer or layers comprises a charge transport material, the single-layer charge transport layer or second pass charge transport layer comprising:
a polytetrafluoroethylene particle dispersion-charge transport layer composition disposed as the single charge transport layer on a charge generation layer or as the second pass charge transport layer on a first charge transport layer;
the polytetrfluoroethylene particle dispersion-charge transport layer composition being prepared by
a) contacting surfactant, polytetrafluoroethylene particles and at least one first solvent in the absence of polymer binder to form a polytetrafluoroethylene particle slurry;
b) adding and mixing the polytetrafluoroethylene particle slurry of a) to a composition comprising at least one polymer binder and at least one second solvent which is the same or different from the first solvent and processing to form a polytetrafluoroethylene particle dispersion;
c) carrying out a second mixing with a base charge transport layer or small molecule transport layer solution to form a polytetrafluoroethylene particle dispersion-charge transport layer composition; and
d) disposing the polytetrafluoroethylene particle dispersion-charge transport layer composition formed in c) as a single-layer charge transport layer onto a charge generation layer or as a second pass charge transport layer onto a first charge transport layer; and
an optional overcoat layer.

13. The imaging member of claim 12, wherein the at least one polymer binder is selected from the group consisting of polyester, polystyrene, polycarbonate, and mixtures and combinations thereof.

14. The imaging member of claim 12, wherein the at least one polymer binder is a polycarbonate binder.

15. The imaging member of claim 12, wherein the at least one polymer binder is Makrolon®.

16. The imaging member of claim 12, wherein the polytetrafluoroethylene particle dispersion contains from about 5 to about 45 percent by weight of the polytetrafluoroethylene particles versus the weight of total dispersion and from about 0.5 to about 10 percent by weight of the surfactant versus weight of PTFE.

17. The imaging member of claim 12, wherein the surfactant is a fluorine-containing graft copolymer based on methylmethacrylate.

18. The imaging member of claim 12, wherein the surfactant is selected from the group consisting of GF300, Novec™ fluorosurfactant FC-4430, Novec™ fluorosurfactant FC-4432, Zonyl® FS-300, and mixtures and combinations thereof.

19. The imaging member of claim 12, wherein the at least one first solvent and the at least one second solvent are independently selected from the group consisting of methylene chloride, tetrahydrofuran, monochlorobenzene, toluene, hexane, cyclohexane, cyclohexanone, 1,1,2-trichloroethane, monochlorobenzene and mixtures and combinations thereof.

20. The imaging member of claim 12, wherein the polytetrafluoroethylene particles have a primary particle size of from about 0.2 micrometer to about 0.4 micrometer.

21. An image forming apparatus for forming images on a recording medium comprising:
1) a photoreceptor member having a charge retentive surface to receive an electrostatic latent image thereon, wherein said photoreceptor member comprises a metal or metallized substrate, a charge generating layer, and a single-layer charge transport layer or a two-layer charge transport layer comprising a first charge transport layer and a second pass charge transport layer, wherein the charge transport layer or layers comprises a charge transport material, the single-layer charge transport layer or second pass charge transport layer comprising:
a polytetrafluoroethylene particle dispersion-charge transport layer composition disposed as the single charge transport layer on the charge generation layer or as the second pass charge transport layer on the first charge transport layer;
the polytetrfluoroethylene particle dispersion-charge transport layer composition being prepared by a) contacting surfactant, polytetrafluoroethylene particles and at least one first solvent in the absence of polymer binder to form a polytetrafluoroethylene particle slurry; b) adding and mixing the polytetrafluoroethylene particle slurry of a) to a composition comprising at least one polymer binder and at least one second solvent which is the same or different from the first solvent and processing to form a polytetrafluoroethylene particle dispersion; c) carrying out a second mixing with a base charge transport layer or small molecule transport layer solution to form a polytetrafluoroethylene particle dispersion-charge transport layer composition; and d) disposing the polytetrafluoroethylene particle dispersion-charge transport layer composition formed in c) as a single-layer charge transport layer onto a charge generation layer or as a second pass charge transport layer onto a first charge transport layer;
2) a development component to apply a developer material to said charge-retentive surface to develop said electrostatic latent image to form a developed image on said charge-retentive surface;
3) a transfer component for transferring said developed image from said charge-retentive surface to another member or a copy substrate; and
4) a fusing member to fuse said developed image to said copy substrate.
